(19) United States
(12) Patent Application Publication
(10) Pub. No.: US 2005/0244066 A1
(43) Pub. Date: Nov. 3, 2005

(54) Method for video data status determination and data transmission system

(75) Inventors: Hsin-I Huang, Taipei City (TW); Chang-Hung Lee, Dounan Jen (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/117,087

(22) Filed: Apr. 28, 2005

(30) Foreign Application Priority Data
Apr. 30, 2004 (TW) 93112164

(51) Int. Cl. G06K 9/36

(52) U.S. Cl. 382/239

(57) ABSTRACT

A method for video data status determination. Video data comprising frames is first received. A frame status of the video data is then determined according to a frame change rate of the frames. The frame change rate indicates a frame change amount over a predetermined time period. The determined frame status is provided as a basis for data encoding to reduce data manipulation time.

### BACKGROUND

The present invention relates to video data status determination methods, and in particular to methods for dynamically determining video data status dynamically during data transmission.

With the diversification of computer related products, the requirement for video data transmission via wireless communication is increasing. Video data is classified as static or dynamic according to the amount of change in data frames over a period of time. Dynamic video data, such as a movie, may be interchanged with static video data, such as slides, in a video data transmission system. For example, slides may first be shown and a movie may then be displayed in the same presentation.

Conventionally, transmitted video data may be encoded in JPEG (Joint Photographic Experts Group) or in MPEG (Motion Photographic Experts Group) format. FIG. 1 is a diagram of an embodiment of a conventional video data transmission system. The transmitter first obtains video data from the data source 100. The obtained video data is then divided into video data frames 102. Next, the video data frames 102 are encoded by the encoder 104 and transferred to a transmission package. The transmission package is adjusted by the streaming module 106 and transmitted by the wireless transmission module 106 through the wireless network 110.

The wireless network receiving module 112 in the receiver receives the transmitted package through the wireless network 110. The received package is first transferred by the streaming module 114 and then decoded by the decoder 116 into video data frames 118. The video data frames are provided to other reading devices 120, such as renders, for output and display.

Some problems exist in the mentioned conventional method, particularly when static and dynamic video data are frequently interchanged, as static video data is typically encoded in JPEG format while dynamic video data encoded in MPEG format. If static and dynamic video data are interchanged frequently, the conventional method can only adopt one encoding method for encoding static and dynamic data, thus, affecting the transmission result and wasting resources on data manipulation.

Some modified systems can partially resolve the previously mentioned problems. The modified systems all focus on optimizing the encoding format, such as optimized MPEG format. In actual applications, an encoder and a decoder are installed in pairs, such as a CODEC. Modified systems, optimizing the encoding and decoding procedures only, cannot resolve the data manipulation and transmission waste problems. For example, a system adopting an optimized MPEG format for encoding and decoding video data, when the transmitted video data is static video data, the number of the data frames will not be reduced and the system may process each frame of the video data individually, placing unnecessary processing burden on the system.

### SUMMARY

Accordingly, an object of embodiments of the invention is to determine a frame status of video data dynamically before data transmission and to encode the video data accordingly.

To achieve the foregoing and other objects, embodiments of the invention are directed to novel methods and systems for video data status determination. The method first receives video data comprising frames. The video data includes static and dynamic video data. Next, a frame status of the video data is determined according to a frame change rate of the frames. The frame change rate is defined as a frame change amount after a predetermined time period. The determined frame status can then be provided to an encoder for data encoding.

### BRIEF DESCRIPTION OF THE DRAWINGS

Embodiments of the present invention can be more fully understood by reading the subsequent detailed description and examples with references made to the accompanying drawings, wherein:

FIG. 1 is a diagram of an embodiment of a conventional video data transmission system.

FIG. 2a is a flowchart of a first embodiment of a video data status determination method.

FIG. 2b is a flowchart of the first embodiment of the determination of the frame status.

FIG. 3 is a diagram of the first embodiment of a machine-readable storage medium for storing a computer program providing a video data status determination method.

FIG. 4 is a diagram of a second embodiment of a video data transmission system.

FIG. 5 is a diagram of a third embodiment of a video data status determination.

FIG. 6 is a diagram of a fourth embodiment of a video data transmission system applied to the video data status determination method.

### DETAILED DESCRIPTION

As summarized above, embodiments of the present invention are directed to novel methods and systems for overcoming conventional video data transmission problems.

### First Embodiment

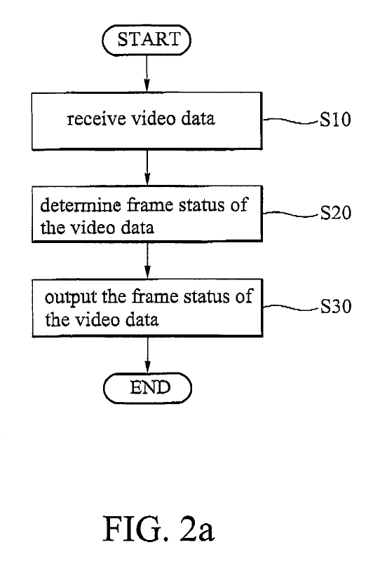

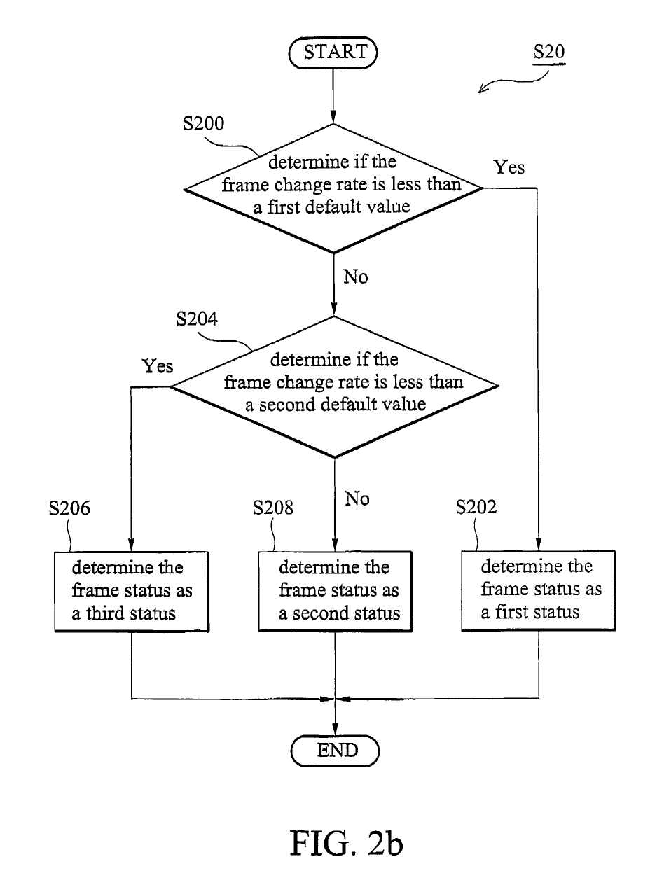

FIG. 2a is a flowchart of a first embodiment of a video data status determination method. In this embodiment, a method for video data status determination is provided. Video data comprising static and dynamic video data is first received (step S10). The received video data can be divided into frames. Next, a frame status of the video data is then determined according to a frame change rate (step S20). The frame change rate is defined as a frame change amount over a predetermined time period. For example, the frame change rate may be the frame change amount during one second. Finally, the frame status of the video data is output to a video data encoder (step S30).

FIG. 2b is a flowchart of the first embodiment of the determination of the frame status. The detailed steps of the determination of the frame status are provided in the following. The frame change rate is first determined if it is less than a first default value (step S200). If the frame change rate is less than the first default value, the frame status is determined as a first status (step S202). When the frame change rate is equal or more than the first default value, the frame change rate is determined if it is less than a second default value (step S204). If the frame change rate is less than the second default value, the frame status is determined as a second status (step S208). If the frame change rate is larger than the second default value, the frame status is determined as a third status (step S206).

The first and the second default values are assigned according to the video data attributes, such as slides, low-speed movie, or high-speed movie. In the determination of the frame status, the first, the second, and the third status are applied to a first, a second, and a third predetermined time period respectively. The first predetermined time period is larger than the second predetermined time period and the second predetermined time period is larger than the third predetermined time period.

The output video data is encoded using a static, dynamic, or high-speed dynamic encoding method according to the determined frame status. That is, the video data is encoded using a static frame encoding method if the frame status is determined as the first status. The video data is encoded using a dynamic frame encoding method if the frame status is determined as the second status. The video data is encoded using a high-speed dynamic frame encoding method if the frame status is determined as the third status.

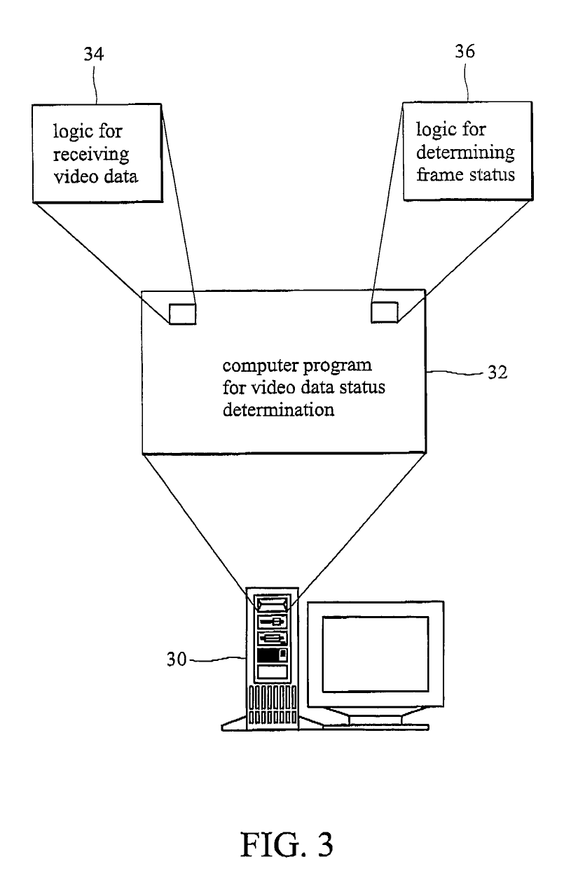

The previously mentioned method can be implemented in computer programs. FIG. 3 is a diagram of the first embodiment of a machine-readable storage medium for storing a computer program providing a video data status determination method. As shown in FIG. 3, machine-readable storage medium 30 stores a computer program 32. The computer program 32 mainly comprises logic for receiving video data 34 and logic for determining frame status 36.

### Second Embodiment

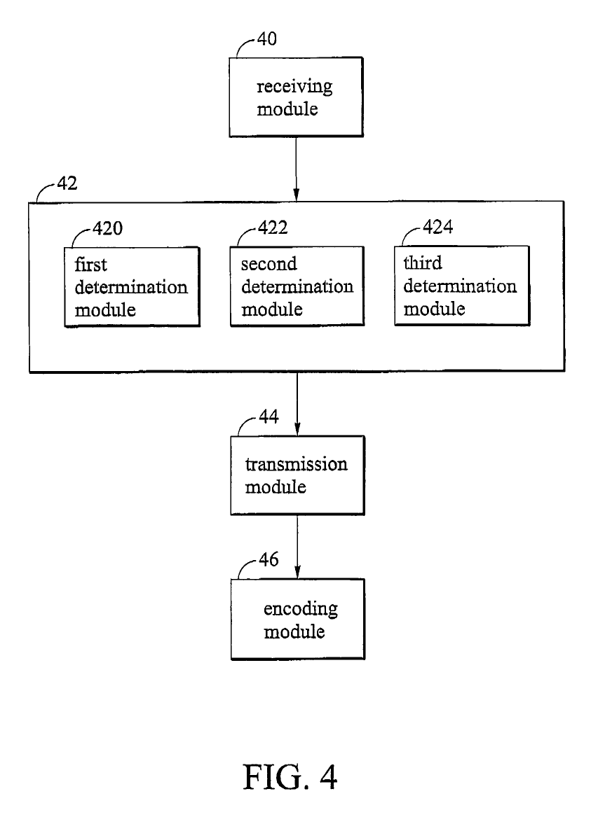

FIG. 4 is a diagram of a second embodiment or a video data transmission system. In this embodiment, a video data transmission system comprises a receiving module 40, a determination module 42, a transmission module 44, and an encoding module 46.

The receiving module 42 receives video data, comprising frames. The video data comprises static and dynamic video data. The determination module 42 determines a frame status of the video data according to a frame change rate of the frames. The frame change rate indicates a frame change amount over a predetermined time period.

The determination module 42 further comprises a first determination module 420, a second determination module 422, and a third determination module 424. The first determination module 420 determines the frame status as a first status if the frame change rate is less than a first default value. The second determination module 422 determines the frame status as a second status if the frame change rate is larger than the first default value and less than a second default value. The third determination module 424 determines the frame status as a third status if the frame change rate is larger than the second default value.

The first and the second default values are assigned according to attributes of the video data. The first, the second, and the third status are applied to a first, a second, and a third predetermined time period respectively. The first predetermined time period is larger than the second and the second predetermined time period is larger than the third.

The transmission module 44 transmits the video data according to the frame status. The encoding module 46 encodes the video data according to the determined frame status. The encoding module 46 encodes the video data using a static frame encoding method when the first determination module 420 determines the frame status as the first status. The encoding module 46 encodes the video data using a dynamic frame encoding method when the second determination module 422 determines the frame status as the second status. The encoding module 46 encodes the video data using a high-speed dynamic frame encoding method when the third determination module 424 determines the frame status as the third status.

### Third Embodiment

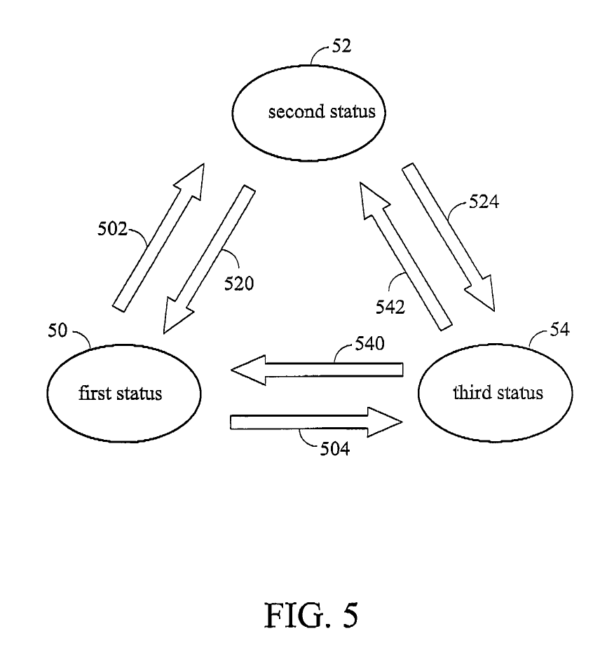

FIG. 5 is a diagram of a third embodiment of a video data status determination. In this embodiment, the video data frame status is classified into a first status 50, a second status 52, and a third status 54. A first and a second default values are assigned according to the attributes of the video data.

If the present frame status of the video data is the first status 50, a frame change amount during a first predetermined time period is first calculated to obtain a frame change rate. If the frame change rate is larger than the first default value and less than the second default value, the frame status is transferred from the first status 50 to the second status 52, as shown in FIG. 5, 502. If the frame change rate is larger than the second default value, the frame status is transferred from the first status 50 directly to the third status 54, as shown in FIG. 5, 504.

When the present frame status is the second status 52, a frame change rate is calculated according to a second predetermined time period. If the frame change rate is less than the first default value, the frame status is transferred from the second status 52 to the first status 50, as shown in FIG. 5, 520. If the frame change rate is larger than the second default value, the frame status transfers from the second status 52 to the third status 54, as shown in FIG. 5, 524.

When the present frame status is the third status 54, a frame change amount during a third predetermined time period is calculated to obtain a frame change rate. If the frame change rate is larger than the first default value and less than the second default value, the frame status is transferred from the third status 54 to the second status 52, as shown in FIG. 5, 542. If the frame change rate is less than the first default value, the frame status is transferred from the third status 54 to the first status 50, as shown in FIG. 5, 540.

As mentioned above, embodiments of the present invention provide a method for determining frame status dynamically. In one time period, video data is encoded according to a frame status thereof and a frame status of video data in next time period is determined. Thus, the data processing and encoding can be adjusted according to the determined frame status, reducing the time required by data processing.

### Fourth Embodiment

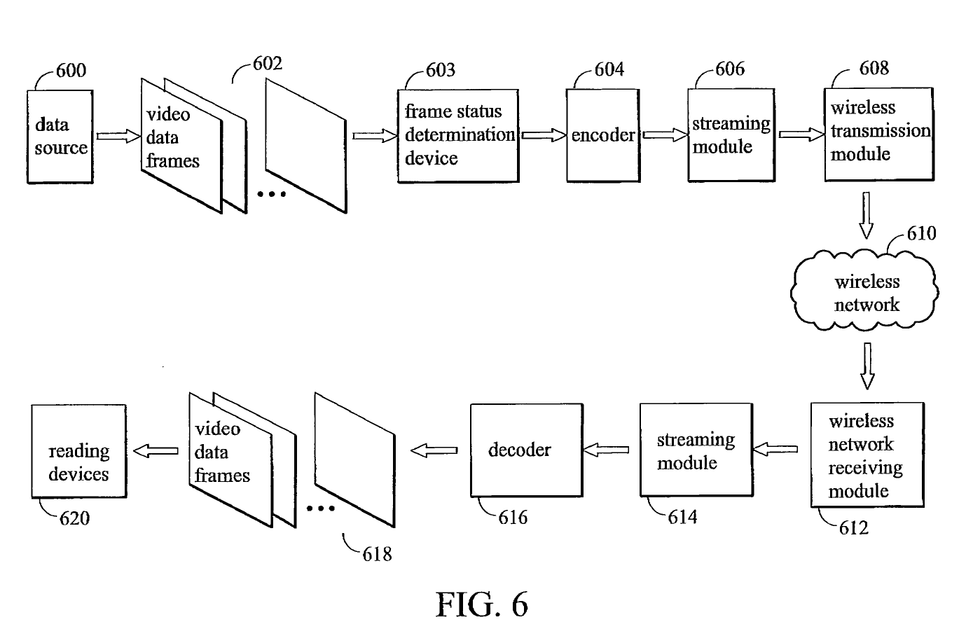

FIG. 6 is a diagram of a fourth embodiment of a video data transmission system applied to the video data status determination method. In this embodiment, a video data transmission system applied to the inventive method is disclosed. The transmitter first obtains video data from the data source 600. The obtained video data is then divided into video data frames 602. Next, a frame status of the video data frames 602 is determined by a frame status determination device 603. The video data frames 602 are then encoded by the encoder 604 and transferred to a transmission package. The transmission package is adjusted by the streaming module 606 and transmitted by the wireless transmission module 608 through the wireless network 610.

The wireless network receiving module 612 in the receiver receives the transmitted package through, the wireless network 610. The received package first transferred by the streaming module 614 and then decoded by the decoder 616 into video data frames 618. The video data frames are provided to other reading devices 620, such as renders, for output and display.

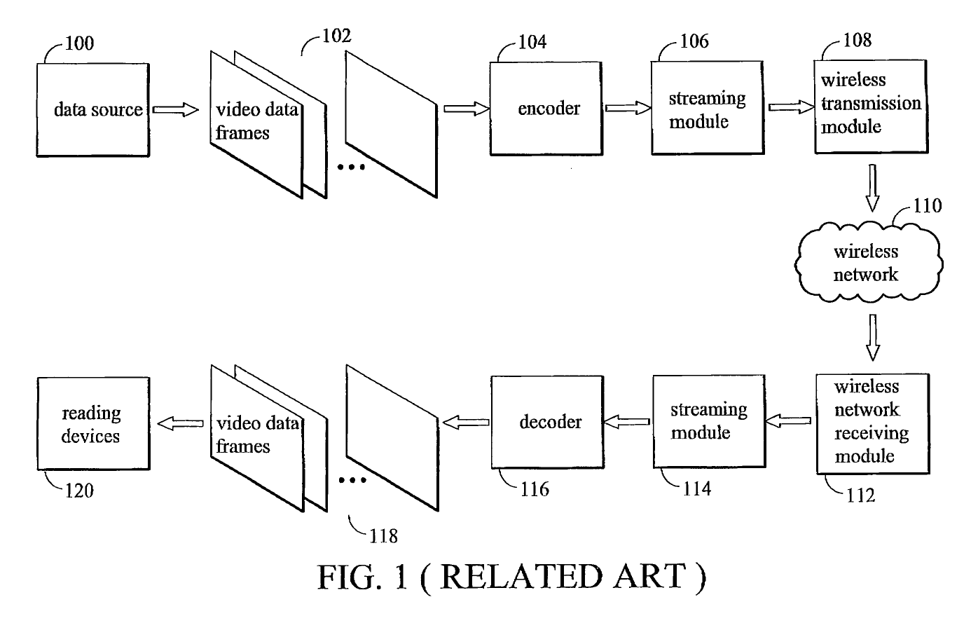

Comparing FIG. 1 with FIG. 6, one frame status determination device is added in the system to execute frame status determination function prior to data encoding. The frame status determination device can be implemented as an isolated device attached to the system. Otherwise, the frame status determination device can be integrated with an encoder or a CODEC.

Thus, embodiments of methods and systems of video data status determination are provided. The determined frame status can be provided to an encoder for data encoding, presenting significant advantages for video data manipulation.

It will be appreciated from the foregoing description that the methods and systems described herein provide a dynamic and robust solution to video data manipulation problems. If, for example, the assignment of the default values or the classification of the frame status is changed, methods and systems of the present invention can be revised accordingly.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for video data status determination, comprising the steps of:
receiving video data, wherein the video data comprises a plurality of frames; and
determining a frame status of the video data according to a frame change rate of the frames, wherein the frame change rate is defined as a frame change amount over a predetermined time period.

2. The method for video data status determination as claimed in claim 1, further outputting the frame status of the video data to a video data encoder.

3. The method for video data status determination as claimed in claim 1, wherein the determination of the frame status comprises the steps of:
determining the frame status as a first status if the frame change rate is less than a first default value;
a determining the frame status as a second status if the frame change rate is larger than the first default value and less than a second default value; and
determining the frame status as a third status if the frame change rate is larger than the second default value.

4. The method for video data status determination as claimed in claim 3, wherein the first, the second, and the third status are applied to a first, a second, and a third predetermined time period respectively, wherein the first predetermined time period is larger than the second predetermined time period and the second predetermined time period is larger than the third predetermined time period.

5. The method for video data status determination as claimed in claim 3, wherein the first and the second default values are assigned according to attributes of the video data.

6. The method for video data status determination as claimed in claim 3, wherein the method further encodes the video data using a static frame encoding method when the frame status is determined as the first status.

7. The method for video data status determination as claimed in claim 3, wherein the method further encodes the video data using a dynamic frame encoding method when the frame status is determined as the second status.

8. The method for video data status determination as claimed in claim 3, wherein the method further encodes the video data using a high-speed dynamic frame encoding method when the frame status is determined as the third status.

9. The method for video data status determination as claimed in claim 1, wherein the video data comprises static and dynamic video data.

10. A machine-readable storage medium for storing a computer program providing a video data status determination method, the method comprising the steps of:
receiving video data, wherein the video data comprises a plurality of frames; and
determining a frame status of the video data according to a frame change rate of the frames, wherein the frame change rate is defined as a frame change amount over a predetermined time period.

11. The machine-readable storage medium as claimed in claim 10, wherein the determination of the frame status comprises the steps of:
determining the frame status as a first status if the frame change rate is less than a first default value;
determining the frame status as a second status if the frame change rate is larger than the first default value and less than a second default value; and
determining the frame status as a third status if the frame change rate is larger than the second default value.

12. The machine-readable storage medium as claimed in claim 11, wherein the method further encodes the video data using a static frame encoding method when the frame status is determined as the first status, using a dynamic frame encoding method when the frame status is determined as the second status, and using a high-speed dynamic frame encoding method when the frame status is determined as the third status.

13. A video data transmission system, comprising:
a receiving module, receiving video data comprising a plurality of frames;
a determination module, coupled to the receiving module, determining a frame status of the video data according to a frame change rate of the frames, wherein the frame change rate is defined as a frame change amount in a predetermined time period; and
a transmission module, coupled to the determination module, transmitting the video data according to the frame status.

14. The video data transmission system as claimed in claim 13, wherein the transmission module further comprises an encoding module for encoding the video data according to the frame status.

15. The video data transmission system as claimed in claim 13, wherein the determination module further comprises:
a first determination module, coupled to the receiving module, determining the frame status as a first status if the frame change rate is less than a first default value;
a second determination module, coupled to the receiving module, determining the frame status as a second status if the frame change rate is larger than the first default value and less than a second default value; and
a third determination module, coupled to the receiving module, determining the frame status as a third status if the frame change rate is larger than the second default value.

16. The video data transmission system as claimed in claim 15, wherein the first, the second, and the third status are applied to a first, a second, and a third predetermined time period respectively, wherein the first predetermined time period is larger than the second predetermined time period and the second predetermined time period is larger than the third predetermined time period.

17. The video data transmission system as claimed in claim 15, wherein the first and the second default values are assigned according to attributes of the video data.

18. The video data transmission system as claimed in claim 15, wherein an encoding module encodes the video data using a static frame encoding method when the first determination module determines the frame status as the first status.

19. The video data transmission system as claimed in claim 15, wherein an encoding module encodes the video data using a dynamic frame encoding method when the second determination module determines the frame status as the second status.

20. The video data transmission system as claimed in claim 15, wherein an encoding module encodes the video data using a high-speed dynamic frame encoding method when the third determination module determines the frame status as the third status.

21. The video data transmission system as claimed in claim 13, wherein the video data comprises static and dynamic video data.
